(19) United States
(12) Patent Application Publication
(10) Pub. No.: US 2006/0236100 A1
(43) Pub. Date: Oct. 19, 2006

(54) System and method for enhanced layer of security to protect a file system from malicious programs

(76) Inventors: Guruprasad Baskaran, Bangalore (IN); Kulvir Singh Bhogal, Fort Worth, TX (US); Kanmani Nachimuthu, Houston, TX (US); Lakshmi Potluri, Austin, TX (US)

Correspondence Address: IBM CORP. (WIP);c/o WALDER INTELLECTUAL PROPERTY LAW, P.C., P.O. BOX 832745, RICHARDSON, TX, 75083, US

(21) Appl. No.: 11/109,043

(22) Filed: Apr. 19, 2005

(51) Int. Cl. H04L 9/00

(52) U.S. Cl. 713/165; 713/156; 713/175

(57) ABSTRACT

A system and method for providing an enhanced layer of security to protect the file system from malicious programs are provided. An additional layer of security for protecting data and to minimize successful attacks by malicious programs is provided. This additional layer uses the feature of code signing to verify that the code is from a source which the code claims to be from, and also that the code has not been tampered with by a malicious party. The file system provides a feature by which certificates are mapped to portions of a file system, e.g., files/directories, such that only programs that are certified by those certificates are able to read/modify those portions of the file system.

### BACKGROUND OF THE INVENTION

1. Technical Field

The present invention relates generally to an improved data processing system and method. In particular, the present invention provides a system and method to provide an enhanced layer of security to protect a file system from malicious programs.

2. Description of Related Art

Computer data is organized as files and directories in a file system. These files and directories are protected from illegal access by other users/programs by the security features of the file system which will allow access to the file by only a certain set of users and programs that are run by a certain set of users. However, the integrity of the files/directories may be compromised if a user who has access to a certain file runs a program unintentionally that will harm the file.

For example, a virus may be attached to an electronic mail message that is received by a user having administrative access. When opening the electronic mail message and the attachment to the electronic mail message, the virus attachment will unintentionally be run on the computer. Because the user has administrative access, the virus will have access to all the data of the computer system, such as the registry of the operating system. Thus, the virus may be able to modify the data, such as the registry, to corrupt critical data on the computer, such as to start up a malicious program on a system start up.

Currently, the measures that can be taken to avoid such an occurrence include the user determining to not access electronic mail messages from senders that the user does not recognize or having attachments with names that the user does not recognize. This places the entire burden of determining whether an electronic mail message and/or attachment may have a virus on the user. As a result, errors in judgment may expose the computer system to a virus unintentionally.

Alternatively, some virus protection software scans electronic mail message attachments to determine if the attachment may have a virus attached. Such mechanisms rely on virus definitions that are established by central virus protection software companies. Such mechanisms suffer from a delay between when a new virus is released into a computer network and a time at which the virus protection software company is able to generate the virus definition and determine proper corrective action. Additional delay occurs due to the time it takes for the virus definitions to be loaded by a client from a centralized server and a time at which the client runs the virus scan software. Thus, there is a time period where computer systems are open to attack from new

In view of the above, it would be beneficial to have a system and method to protect computer systems from malicious programs that ensures the integrity of the operating system during all conditions. Moreover, it would be beneficial to have a system and method to protect computer systems from malicious programs such that human error and time delays between the release of a malicious program and the ability to identify the malicious program are eliminated.

### SUMMARY OF THE INVENTION

The present invention provides a system and method for providing an enhanced layer of security to protect the file system from malicious programs. The present invention provides an additional layer of security for protecting data and to minimize successful attacks by malicious programs. The present invention uses the feature of code signing by which a third party can verify that the code is from a source which the code claims to be from, and also that the code has not been tampered with by a malicious party. The file system of the present invention provides a feature by which certificates are mapped to files/directories such that only programs that are authorized by those certificates are able to read/modify the files/directories.

With the mechanisms of the present invention, a system administrator, or other entity with sufficient access permissions, is able to associate one or more certificates with portions of a file system, e.g., individual files, entire directories, groups of files, groups of directories, and the like. The file system maintains one or more data structures in which the associations between portions of the file system and certificates are identified.

When a program is attempted to be run by the operating system, and the program tries to access one or more portions of the file system, the security features of the file system are used to determine if the program is to be provided access to those particular portions of the file system. For example, the security features of the file system will first check to see if the user that is running the program has sufficient permissions to access the portion of the file system in the manner desired, e.g., opening or modifying the portion of the file system. If the user has sufficient permissions, e.g., administrator access, this check will succeed.

At a second level of the security features of the file system, the mechanism of the present invention verifies that the program being run is digitally signed and if so, that the digital signature maps to one or more of the digital certificates associated with the portion of the file system that is being accessed. In the case of malicious programs, since these malicious programs could not be signed by any of the authorized certificate providers, this check will fail and the program will not be permitted to access the portion of the file system.

Thus, the mechanisms of the present invention identify what portions of the file system can be accessed by programs that are digitally signed by which parties. With the present invention, every program that will need to access particular portions of the file system will need to be signed by an authorized certificate issuing party. Thus, for example, every program that needs to modify the registry of the operating system may need to be signed by one of Sun Microsystems, International Business Machines Corporation, or Microsoft Corporation, in order to be provided modification access to the operating system registry.

These certificate issuing parties may have a process in place by which they can receive requests by various software vendors to have their software signed by the certificate issuing party. These certificate issuing parties may then verify that these programs are not malicious in any nature by running them through anti-virus software, running the programs on their own local environments and checking that these programs do not perform any malicious activity, or the like. Once they are satisfied, the certificate issuing parties may sign the code of the programs.

Using digital signatures for authorization will eliminate two problems. One problem is that programs that are not certified by certificates that are associated with a portion of the file system that is attempting to be accessed will not be provided with access to that portion of the file system. A second problem that is addressed by the present invention is that if the program that was certified by the certificate issuing party is tampered with, even by a single byte, the digital signature of the program will not match with the authorized certificate associated with the portion of the file system being accessed. Thus, a malicious party cannot successfully modify a signed portion of code to insert malicious code, in an attempt to circumvent the security of the present invention.

These and other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram of a distributed data processing system in which exemplary aspects of the present invention may be implemented;

FIG. 2 is an exemplary diagram illustrating a server data processing device in which aspects of the present invention may be implemented;

FIG. 3 is an exemplary diagram illustrating a client data processing device in which aspects of the present invention may be implemented;

FIG. 4 is an exemplary diagram illustrating the interaction between the primary operational parties of one exemplary embodiment of the present invention;

FIG. 5 is an exemplary diagram illustrating the operation of the primary operation components of a security mechanism of a file system in accordance with one exemplary embodiment of the present invention; and

FIG. 6 is a flowchart outlining an exemplary operation of one exemplary embodiment of the present invention.

### DETAILED DESCRIPTION OF THE PREFERRED EMBODIMENT

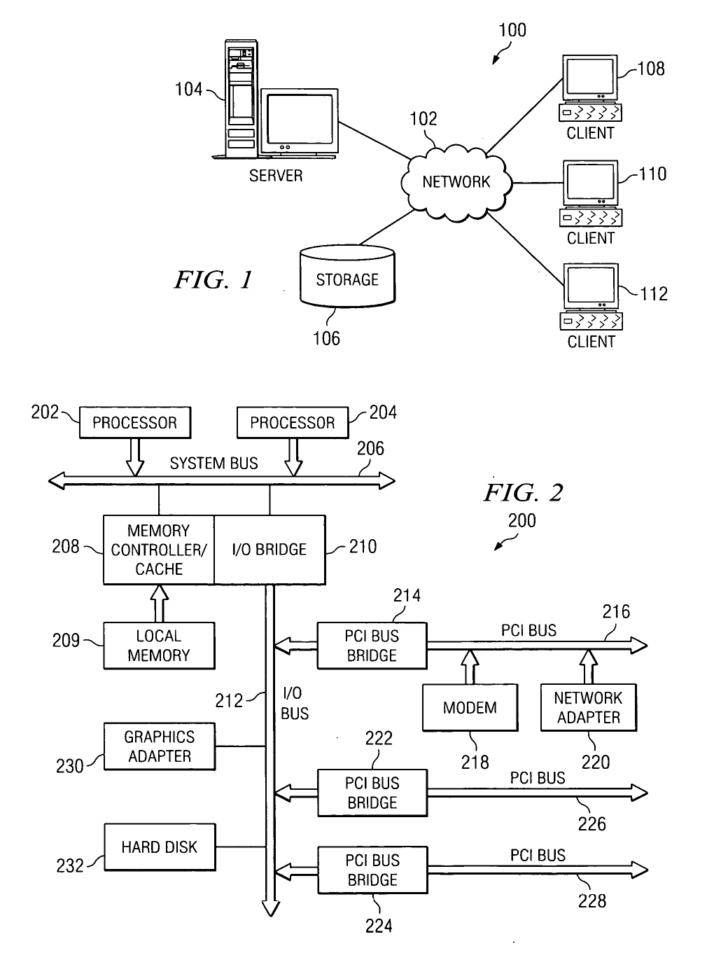

As mentioned above, the present invention is directed to a system and method for providing an enhanced layer of security to protect a file system from malicious programs. The mechanisms of the present invention are especially well suited for use in a distributed data processing system in which programs which may or may not be malicious in nature may be received from unknown parties that are remotely located from a receiving computer system. Thus, in order to provide a context for the description of the exemplary embodiments of the present invention hereafter, FIGS. 1-3 are provided as examples of the data processing systems in which aspects of the present invention may be implemented. It should be appreciated that FIGS. 1-3 are only exemplary and are not intended to state or imply any limitation as to the types or configurations of data processing systems in which the exemplary embodiments of the present invention may be implemented. Many modifications to these data processing systems may be made without departing from the spirit and scope of the present invention.

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O Bus Bridge 210 is connected to system bus 206 and provides an interface to I/O bus 212. Memory controller/cache 208 and I/O Bus Bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

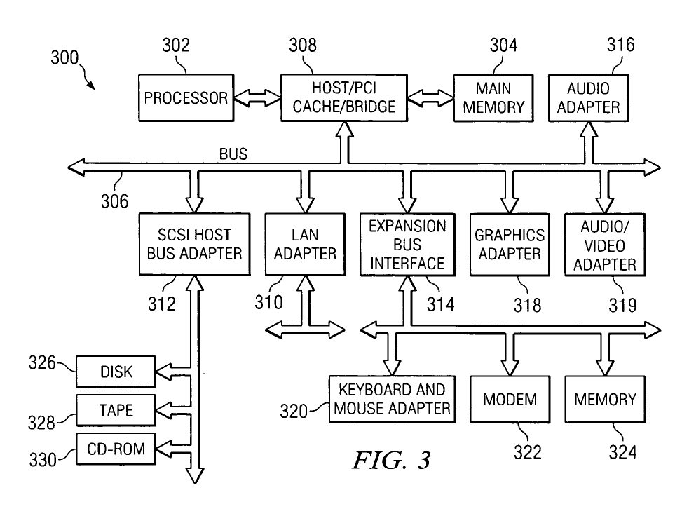

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI Bridge 308. PCI Bridge 308 also may include an integrated memory controller and cache memory for processor 302. Additional connections to PCI local bus 306 may be made through direct component interconnection or through add-in boards. In the depicted example, local area network (LAN) adapter 310, small computer system interface (SCSI) host bus adapter 312, and expansion bus interface 314 are connected to PCI local bus 306 by direct component connection. In contrast, audio 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

As discussed above, the present invention provides a system and method for providing an enhanced layer of security to protect the file system from malicious programs. With the exemplary embodiments of the present invention, an additional layer of security for protecting data and to minimize successful attacks by malicious programs is provided. This additional layer of security uses the feature of code signing by which a third party can verify that the code is from a source which the code claims to be from, and also that the code has not been tampered with by a malicious party. The file system of the present invention provides a feature by which certificates are mapped to files/directories such that only programs that are certified by those certificates are able to read/modify the files/directories.

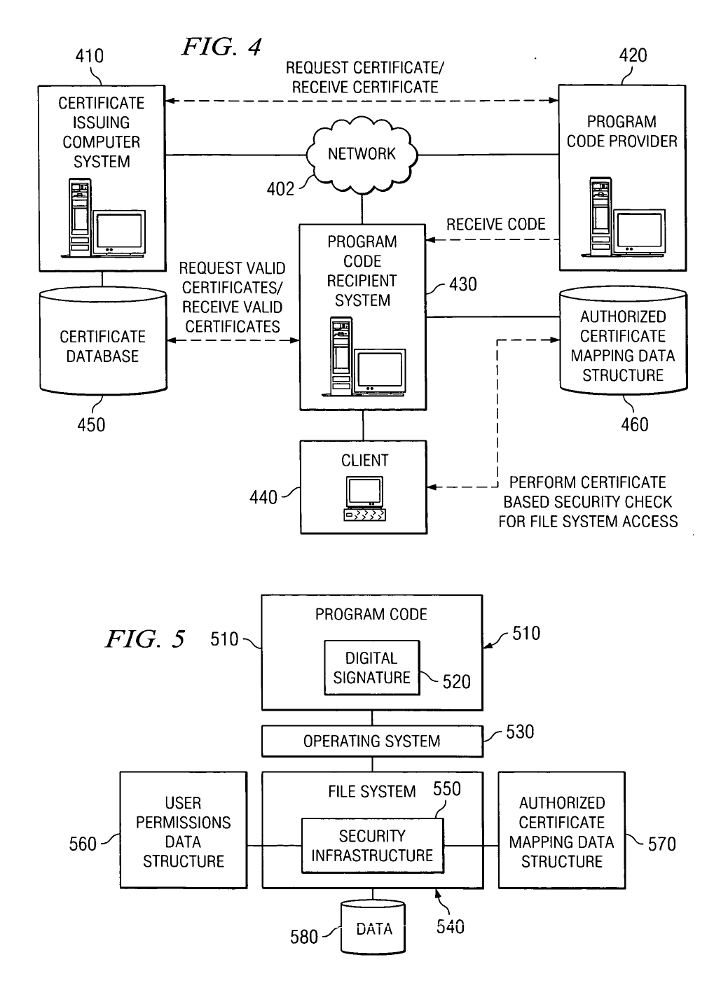

FIG. 4 is an exemplary diagram illustrating the interaction between the primary operational parties of one exemplary embodiment of the present invention. As shown in FIG. 4, with the present invention, every program that will need to access particular portions of a file system of a computing device upon which the program is executed, will need to be signed by an authorized certificate issuing party. As a result, a program code provider 420 must communicate with a certificate issuing entity's computer system 410 to request a digital signature or certificate for their program code. For example, if during execution of the program code, the program code needs to modify the registry of the operating system, the program code must be signed by an authorized third party, e.g., the certificate issuing computer system 410, in order to be provided modification access to the operating system registry.

The certificate issuing computer system 410 is associated with a certificate issuing entity that is a trusted third party. For example, the certificate issuing entity may be an operating system provider such as Microsoft, International Business Machines Corporation, Sun Microsystems, or the like. Other trusted third parties may be used as certificate issuing entities without departing from the spirit and scope of the present invention.

These certificate issuing parties preferably have a process in place by which they receive requests from computer program providers 420 to have their computer programs signed by the certificate issuing party. These certificate issuing parties may then verify that these programs are not malicious in any nature by running them through anti-virus software, running the programs on their own local environments and checking that the programs do not perform any malicious activity, or the like. Once they are satisfied, the certificate issuing parties may sign the program code and provide the certificate or signed program code to the program code provider 420.

The generation of digital signatures and digital certificates is generally known in the art and thus, a detailed description of this process is not provided herein. For example, one type of digital signature and certificate based verification system is described in U.S. Pat. No. 6,292,897, entitled “Undeniable Certificates for Digital Signature Verification,” issued Sep. 18, 2001, which is hereby incorporated by reference. Other digital signature and digital certificate generation mechanisms may be used as a basis for the digital certificate and digital signature generation in accordance with the present invention without departing from the spirit and scope of the present invention.

The digitally signed program code may then be provided to a program code recipient system 430 for execution. This digitally signed program code may be a program that is specifically downloaded by a user of the program code recipient system 430, a client computing device 440 associated with the program code recipient system 430, or may be an applet, or other type of program, that is automatically downloaded in response to user operations of the program code recipient system 430 or client computing device 440. Moreover, the digitally signed program code may be an attachment to an electronic message which is to be executed when the attachment is run or when the electronic message is accessed by a user of the program code recipient system 430 or client computing device 440. In short, the particular mechanism used to provide the program code to a recipient computer system may be any suitable mechanism depending upon the particular implementation of the present invention.

The program code recipient computer system 430 may be a computer system through which data and programs may be obtained via the network 402 and provided to client computer systems, e.g., client computer system 440. The received program code may be executed in the program code recipient computer system 430 or may be provided to a client computer system 440 for execution. For example, the program code recipient computer system 430 may be an electronic mail server, an Internet Service Provider server, a client computer itself, or the like.

In the depicted example, it is assumed that the program code recipient computer system 430 is a server computer of a local area network, an intranet, or the like. The server computer may operate, for example, as an electronic mail server for the local area network, intranet, etc.

Once the program code is received, either the program code recipient computer system 430, or the client computer system 440, depending upon the implementation, may execute the program code. In executing the program code, if the program code requests access to a portion of the file system of the program code recipient computer system 430 or the client computer system 440, whichever is actually running the program code, then the file system performs a set of security checks to determine if the program code is to be provided with the requested access. This set of security checks includes an additional security layer for determining if a digital signature of the program code matches a certificate associated with the portion of the file system for which access is requested.

That is, with the mechanisms of the present invention, a system administrator, or other entity with sufficient access permissions, is able to associate one or more certificates of authorized third party certificate issuing entities with portions of a file system, e.g., individual files, entire directories, groups of files, groups of directories, and the like. An authorized entity may select a portion of the file system, such as via a graphical user interface, and then select a security option associated with the portion of the file system. This security option may, in addition to other security mechanisms, provide an option to associate the selected portion of the file system with a particular certificate or group of certificates. In associating such certificates with the selected portion of the file system, only program code that has digital signatures that map to one or more of these certificates is permitted to access that portion of the file system.

As mentioned above, the authorized entity may associate individual certificates with a portion of the file system or may associate groups of certificates with the portion of the file system. For example, a system administrator may decide to permit all program code that is signed by IBM Corporation to access an operating system registry. With the present invention, the system administrator may select IBM Corporation as a certificate issuing entity whose certificates, as a group, are permitted to access the operating system registry. This group may then be mapped to specific certificates issued by IBM Corporation when performing verification.

For example, the program code recipient computer system 430 may be set to access the certificate database 450 of a certificate issuing computer system 410 to obtain the authorized certificates that have been issued by that certificate issuing party. These certificates may be stored in an authorized certificate mapping data structure 460 in association with a certificate group identifier, e.g., IBM Corporation. In addition, identifiers of portions of the file system may be stored in association with their corresponding authorized certificates or certificate groups in the authorized certificate mapping data structure 460. With regard to certificate groups, the mapping of a portion of a file system to a certificate group may also result in the mapping of a certificate group to individual certificates using the authorized certificates mapping data structure 460 when verifying whether program code is able to access a portion of the file system.

When the program code attempts to access one or more portions of the file system, the security features of the file system are used to determine if the program code is to be provided access to those particular portions of the file system. For example, the security features of the file system will first check to see if the user that is running the program, e.g., the user of the program code recipient system 430 or the client computer system 440, has sufficient permissions to access the portion of the file system in the manner desired, e.g., opening or modifying the portion of the file system. If the user has sufficient permissions, e.g., administrator access, this check will succeed. This check may be performed in any known manner, such as using Access Control Lists (ACLs) or the like, without departing from the spirit and scope of the present invention.

At a second level of the security features of the file system, the mechanism of the present invention verifies that the program being run is digitally signed and if so, that the digital signature maps to one or more of the digital certificates associated with the portion of the file system that is being accessed. Thus, the portion of the file system that needs to be accessed by the program code is identified and a lookup of the authorized certificates for this portion of the file system is performed using the authorized certificate mapping data structure 460. The digital signature of the program code is then compared to the authorized certificates for the portion of the file system to determine if there is a match. If so, then the program code is permitted to access the portion of the file system. In the case of malicious programs, since these malicious programs could not be signed by any of the authorized certificate issuing parties, this check will fail and the program code will not be permitted to access the portion of the file system.

Using digital signatures for authorization will eliminate two problems. One problem is that programs that are not certified by certificates that are associated with a portion of the file system that is attempting to be accessed will not be provided with access to that portion of the file system. A second problem that is addressed by the present invention is that if the program that was certified by the certificate issuing party is tampered with, even by a single byte, the digital signature of the program will not match with the authorized certificate associated with the portion of the file system being accessed. Thus, a malicious party cannot successfully modify a signed portion of code to insert malicious code, in an attempt to circumvent the security of the present invention.

Thus, the present invention provides a mechanism by which certificates of trusted parties may be associated with portions of a file system, i.e. at a file system level, and an additional layer of security is provided for determining whether programs are permitted to access portions of the file system. This additional layer of security is exercised each time program code attempts to access portions of the file system. Thus, not only is it necessary for the user that executes the program code to have sufficient permissions to access the portions of the file system, but the program code itself must be signed by a trusted party and must have been given permission by a trusted party to access the portions of the file system.

FIG. 5 is an exemplary diagram illustrating the operation of the primary operation components of a security mechanism of a file system in accordance with one exemplary embodiment of the present invention. As shown in FIG. 5, when a program code 510, having a digital signature 520, is received and executed by an operating system 530, the program code 510 may need to access portions of the file system 540. In response to a request to access a portion of the file system 540, the security infrastructure 550 checks the user's identity in the user permissions data structure 560 to determine if the particular user running the program code 510 has sufficient permission to access the identified portion of the file system 540. If not, then access is denied and the program code 510 execution is stopped.

If the user has sufficient permissions to access the identified portion of the file system 540, an additional layer of the security infrastructure 550 checks the digital signature 520 of the program code 510 to see if the program code 510 is permitted to access the portion of the file system 540. That is, the security infrastructure 550 of the file system 540 extracts the digital signature 520 of the program code 510. The security infrastructure 550 retrieves authorized certificate information from the authorized certificate mapping data structure 570 and compares the extracted digital signature to the authorized certificate information to determine if the digital signature maps to an authorized certificate for the portion of the file system 540. If not, the access request is denied and the execution of the program code 510 is stopped. If the digital signature maps to an authorized certificate for the portion of the file system 540, then access to the data 580 for that portion of the file system 540 is permitted.

As a real world example of the mechanisms of the present invention, it is beneficial to consider the registry file of the Microsoft Windows™ operating system. The registry file is a critical file for the proper functioning of the Windows™ operating system and is a main target for many viruses and other malicious programs. For example, the virus “mydoom@mm” was transmitted as an email attachment and, when the unsuspecting user executed this virus on his/her machine, it created registry entries to launch itself on system start up, among many other things.

With the security features of the present invention, this malicious attack on the registry of the computer system may be prevented. With the present invention, when an authorized user accesses the security options associated with the registry, such as by “right-clicking” on the registry file in the Windows™ operating system graphical user interface, among the other known security options that are provided are additional options for associating certificates with the registry file. For example an “add certificates” virtual button or other type of graphical user interface tool may be provided for selecting certificates to associate with the registry file.

Using the “add certificates” tool in the security options for the registry file, the present invention permits an authorized user to add digital certificates to the registry file such that the file system maintains this association of digital certificates with an identifier of the registry file in an authorized certificates mapping data structure. Through this tool, individual certificates or groups of certificates may be associated with the registry file. Thus, for example, the authorized user may use the “add certificates” tool to add certificates from IBM Corporation, Sun Microsystems, Microsoft, and the like.

When a virus, such as “mydoom@mm” is received in the inbox of the electronic mail program of the computer system and the user mistakenly executes the virus, the virus will try to access the registry file to modify it. The security mechanisms of file system, in accordance with the present invention, will first check to see if the user that is running the program has sufficient permissions to access the registry file. If not, the access attempt is denied. For purposes of this description, it is assumed that the user has sufficient permissions to access the registry file. As a result, this first security check will succeed.

Thereafter, at a second level of security, the file system verifies that the program code that is being executed is digitally signed, and if so, that the digital signature maps to any of the digital certificates associated with the registry file it is trying to modify. This may involve looking up the authorized certificates for the registry file in the authorized certificates mapping data structure and comparing the digital signature of the program code to these authorized certificates. If the program code has a digital signature that maps to an authorized digital certificate, then access to the registry file is permitted. In the case of a virus, such as “mydoom@mm,” this program would not be signed by a trusted third party whose certificates are associated with the registry file and as a result, the access attempt from such a malicious program will fail. Thus, the virus will not be permitted to modify the registry file.

As can be seen from the above example, the security mechanisms of the present invention provide an extra layer of security at the file system level that prevents malicious programs from accessing portions of a file system which are protected using authorized certificate associations. In this way, even though the user may have sufficient permissions to access these portions of the file system, if the program that is executing and requesting access is not authorized by a trusted party to access these portions of the file system, then the access will be denied. Thus, the mechanisms of the present invention avoid unintentional exposure of portions of the file system to malicious programs by an authorized user.

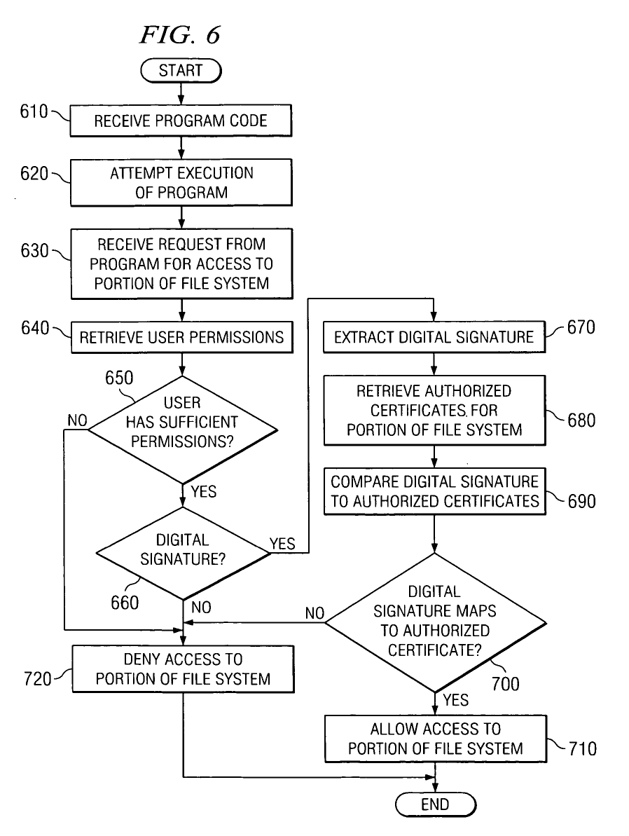

FIG. 6 is a flowchart outlining an exemplary operation of one exemplary embodiment of the present invention. It will be understood that each block of the flowchart illustration, and combinations of blocks in the flowchart illustration, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustration support combinations of means for performing the specified functions, combinations of steps for performing the specified functions and program instruction means for performing the specified functions. It will also be understood that each block of the flowchart illustration, and combinations of blocks in the flowchart illustration, can be implemented by special purpose hardware-based computer systems which perform the specified functions or steps, or by combinations of special purpose hardware and computer instructions.

As shown in FIG. 6, the operation starts by receiving program code that is to be executed in the computer system resulting in a request for access to a portion of the file system (step 610). An attempt to execute the received program code is then performed (step 620). As a result, a request for access to a portion of the file system is generated (step 630).

In response to the request for access to a portion of the file system, user permissions for the user executing the program code are retrieved (step 640). A determination is made as to whether the user has sufficient permissions to access the portion of the file system (step 650). If not, access to the portion of the file system is denied (step 720) and the operation terminates. If the user has sufficient permissions, a determination is made as to whether the program code is digitally signed (step 660).

If not, any access to the file system will be denied (step 720) and the operation terminates. If the program code is digitally signed, then the digital signature is extracted (step 670). The authorized certificates for the identified portion of the file system are then retrieved (step 680) and the digital signature is compared to the authorized certificates (step 690). A determination is made as to whether the digital signature maps to an authorized certificate for the portion of the file system (step 700). If not access to the portion of the file system is again denied (step 720). If the digital signature maps to an authorized certificate for the portion of the file system, then access to the portion of the file system is allowed (step 710). The original requested operation may then be carried out (e.g., a registry modification) and the operation of the present invention then terminates.

It should be noted that, in addition to the above, following denial or allowance of access to the file system, various other operations may be performed to further enhance the security of the file system. For example, if an access attempt is denied through the operation of the present invention as outlined in FIG. 6 above, a notification of the denial of access may be generated and sent to a user, system administrator, or the like. In addition, a log of the denial of access may be generated and stored for later use. Moreover, access attempts that are allowed may also be logged for later use. Other processing may be performed following the denial or allowing of access to the file system as will become apparent to those of ordinary skill in the art in view of the present description.

Thus, the present invention provides an improved mechanism for protecting the integrity of portions of a file system at the file system level. The present invention prevents unintentional exposure of portions of the file system to malicious attack by authorized users of the file system.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for authorizing access to portions of a file system, comprising:
receiving, from an executing program, a request to access a portion of a file system, the request including an identifier of the portion of the file system;
retrieving, based on the identifier of the portion of the file system, authorized certificate information associated with the identifier of the portion of the file system, identifying authorized certificates of trusted parties that may be used to access the portion of the file system;
determining if the executing program corresponds to an authorized certificate associated with the portion of the file system; and
permitting access to the portion of the file system only if the executing program corresponds to an authorized certificate associated with the portion of the file system.

2. The method of claim 1, wherein the portion of the file system is one of a file, a group of files, a directory, and a group of directories in the file system.

3. The method of claim 1, wherein the portion of the file system is a registry file of the file system.

4. The method of claim 1, further comprising:
receiving a user selection of the portion of the file system;
receiving a user selection of one or more certificates to be associated with the portion of the file system; and
storing an identifier of the portion of the file system in association with one or more identifiers of the one or more certificates associated with the portion of the file system.

5. The method of claim 1, further comprising:
determining if a user that initiated execution of the program has sufficient permissions to access the portion of the file system in a manner necessary for execution of the program; and
if the user that initiated execution of the program does not have sufficient permissions to access the portion of the file system in the manner necessary, denying access by the executing program to the portion of the file system.

6. The method of claim 5, wherein the steps of retrieving authorized certificate information associated with the identifier of the portion of the file system, determining if the executing program corresponds to an authorized certificate associated with the portion of the file system, and permitting access to the portion of the file system are performed only if the user that initiated the execution of the program has sufficient permissions to access the portion of the file system in the manner necessary.

7. The method of claim 1, wherein the method is implemented each time the executing program requests access to the portion of the file system.

8. The method of claim 1, wherein determining if the executing program corresponds to an authorized certificate associated with the portion of the file system includes:
extracting a digital signature of the executing program; and
determining if the digital signature of the executing program maps to an authorized certificate associated with the portion of the file system.

9. A computer program product in a computer readable medium for authorizing access to portions of a file system, comprising:
first instructions for receiving, from an executing program, a request to access a portion of a file system, the request including an identifier of the portion of the file system;
second instructions for retrieving, based on the identifier of the portion of the file system, authorized certificate information associated with the identifier of the portion of the file system, identifying authorized certificates of trusted parties that may be used to access the portion of the file system;
third instructions for determining if the executing program corresponds to an authorized certificate associated with the portion of the file system; and
fourth instructions for permitting access to the portion of the file system only if the executing program corresponds to an authorized certificate associated with the portion of the file system.

10. The computer program product of claim 9, wherein the portion of the file system is one of a file, a group of files, a directory, and a group of directories in the file system.

11. The computer program product of claim 9, wherein the portion of the file system is a registry file of the file system.

12. The computer program product of claim 9, further comprising:
fifth instructions for receiving a user selection of the portion of the file system;
sixth instructions for receiving a user selection of one or more certificates to be associated with the portion of the file system; and
seventh instructions for storing an identifier of the portion of the file system in association with one or more identifiers of the one or more certificates associated with the portion of the file system.

13. The computer program product of claim 9, further comprising:
fifth instructions for determining if a user that initiated execution of the program has sufficient permissions to access the portion of the file system in a manner necessary for execution of the program; and
sixth instructions for denying access by the executing program to the portion of the file system, if the user that initiated execution of the program does not have sufficient permissions to access the portion of the file system in the manner necessary.

14. The computer program product of claim 13, wherein the second, third and fourth instructions are executed only if the user that initiated the execution of the program has sufficient permissions to access the portion of the file system in the manner necessary.

15. The computer program product of claim 9, wherein the first, second, third and fourth instructions are executed each time the executing program requests access to the portion of the file system.

16. The computer program product of claim 9, wherein the third instructions for determining if the executing program corresponds to an authorized certificate associated with the portion of the file system include:
instructions for extracting a digital signature of the executing program; and
instructions for determining if the digital signature of the executing program maps to an authorized certificate associated with the portion of the file system.

17. A system for authorizing access to portions of a file system, comprising:
a processor; and
a data storage device coupled to the processor, wherein the data storage system has an associated file system, and wherein the processor:
receives, from an executing program, a request to access a portion of the file system, the request including an identifier of the portion of the file system,
retrieves, based on the identifier of the portion of the file system, authorized certificate information associated with the identifier of the portion of the file system, identifying authorized certificates of trusted parties that may be used to access the portion of the file system,
determines if the executing program corresponds to an authorized certificate associated with the portion of the file system, and
permits access to the portion of the file system only if the executing program corresponds to an authorized certificate associated with the portion of the file system.

18. The system of claim 17, wherein the processor receives a user selection of the portion of the file system, receives a user selection of one or more certificates to be associated with the portion of the file system, and stores an identifier of the portion of the file system in association with one or more identifiers of the one or more certificates associated with the portion of the file system in the data storage device.

19. The system of claim 17, wherein the processor determines if a user that initiated execution of the program has sufficient permissions to access the portion of the file system in a manner necessary for execution of the program, and denies access by the executing program to the portion of the file system, if the user that initiated execution of the program does not have sufficient permissions to access the portion of the file system in the manner necessary.

20. The system of claim 19, wherein the processor retrieves authorized certificate information associated with the identifier of the portion of the file system, determines if the executing program corresponds to an authorized certificate associated with the portion of the file system, and permits access to the portion of the file system only if the user that initiated the execution of the program has sufficient permissions to access the portion of the file system in the manner necessary.
